(19) United States
(12) Patent Application Publication
(10) Pub. No.: US 2013/0287274 A1
(43) Pub. Date: Oct. 31, 2013

(54) Methods and Apparatuses of Unified Capacitive Based Sensing of Touch and Fingerprint

(71) Applicants: Weidong Shi, Pearland, TX (US); Yang Lu, Pearland, TX (US)

(72) Inventors: Weidong Shi, Pearland, TX (US); Yang Lu, Pearland, TX (US)

(21) Appl. No.: 13/887,351

(22) Filed: May 5, 2013

Related U.S. Application Data
(63) Continuation-in-part of application No. 13/459,207, filed on Apr. 29, 2012.
Application No. 13/459,207 is a continuation-in-part of application No. 13/667,235, filed on Nov. 2, 2012.
Application No. 13/667,235 is a continuation-in-part of application No. 13/757,993, filed on Feb. 4, 2013.
Application No. 13/757,993 is a continuation-in-part of application No. 13/851,086, filed on Mar. 26, 2013.

(51) Int. Cl. G06F 3/044; G06K 9/00

(52) U.S. Cl. CPC G06F 3/044; G06K 9/00006
USPC 382/124; 345/174

(57) ABSTRACT

The present invention describes methods and apparatuses for sensing touches and/or fingerprint images with an integrated device comprising, a transparent touch-fingerprint capacitive sensing array comprising a collection of capacitive sensing cells, a multi-resolution scanline driver circuitry, a multi-resolution column driver circuitry, and a readout circuitry coupling with said transparent touch-fingerprint capacitive sensing array wherein said readout circuitry can transmit digital or analog output of selected capacitive sensing cells.

The present application is a continuation-in-part of U.S. application Ser. No. 13/459,207, entitled “Methods and Apparatus of Integrating Fingerprint Imagers with Touch Panels and Displays”, filed Apr. 29, 2012; The present application is also a continuation-in-part of U.S. application Ser. No. 13/667,235, entitled “Methods and Apparatus for Managing Service Access Using a Touch-Display Device Integrated with Fingerprint Imager”, filed Nov. 2, 2012. The present application is also a continuation-in-part of U.S. application Ser. No. 13/757,993, entitled “Methods and Apparatuses of Transparent Fingerprint Imager Integrated with Touch Display Device”, filed Feb. 4, 2013. The present application is also a continuation-in-part of U.S. application Ser. No. 13/851,086, entitled “Methods and Apparatuses of User Interaction Control with Touch Display Device Integrated with Fingerprint Imager”, filed Mar. 26, 2013. All of which are hereby incorporated by reference in their entireties.

### BACKGROUND OF THE INVENTION

### Field of the Invention

This invention relates to supporting identity based user experiences by a computing apparatus wherein said computing apparatus comprises a biometric touch display.

### BRIEF DESCRIPTION OF THE DRAWINGS

The invention may be better understood, and further advantages and uses thereof more readily apparent, when considered in view of the following detailed description of exemplary embodiments and examples, taken with the accompanying diagrams, in which:

FIG. 1 is a block diagram showing, in one exemplary embodiment of the present invention, the components of a touch-fingerprint apparatus comprising, a transparent touch-fingerprint capacitive sensing array, a multi-resolution scanline driver circuitry, a column driver circuitry, and a readout circuitry coupling with said transparent touch-fingerprint capacitive sensing array;

FIG. 2 is a block diagram showing, in one exemplary embodiment of the present invention, a collection of capacitive sensing cells wherein a sensing cell comprises one transparent thin-film transistor;

FIG. 3 is a block diagram showing, in one exemplary embodiment of the present invention, a collection of capacitive sensing cells wherein a sensing cell comprises two transparent thin-film transistors;

FIG. 4 is a block diagram showing, in one alternative exemplary embodiment of the present invention, a collection of capacitive sensing cells wherein a sensing cell comprises two transparent thin-film transistors;

FIG. 5 is a block diagram showing, in one alternative exemplary embodiment of the present invention, a collection of capacitive sensing cells wherein a sensing cell comprises four transparent thin-film transistors and one reference capacitor;

FIG. 6 is a block diagram, in one exemplary embodiment of the present invention, a scanline driver circuitry comprising a line decoder and a multi-resolution shift register;

FIG. 7 is a block diagram, in one alternative exemplary embodiment of the present invention, a scanline driver circuitry comprising a line decoder and a multi-resolution shift register;

FIG. 8 is a block diagram, in one exemplary embodiment of the present invention, components of a multiple resolution shift register;

FIG. 9 is a block diagram showing, in one exemplary embodiment of the present invention, the components of a column driver circuitry;

FIG. 10 is a block diagram showing, in one exemplary embodiment of the present invention, components of a readout circuitry;

FIG. 11 is a block diagram showing, in one alternative exemplary embodiment of the present invention, components of a readout circuitry;

FIG. 12 is a flowchart showing, in one exemplary embodiment of the present invention, the process of sensing touches and/or fingerprint images with a touch-fingerprint apparatus;

FIG. 13 is a block diagram showing, in one exemplary embodiment of the present invention, selected columns and/or scanlines with subsampling; and

FIG. 14 is a block diagram showing, in one exemplary embodiment of the present invention, selected columns and/or scanlines in fingerprint imaging.

While the patent invention shall now be described with reference to the embodiments shown in the drawings, it should be understood that the intention is not to limit the invention only to the particular embodiments shown but rather to cover alterations, modifications and equivalent arrangements possible within the scope of appended claims. Throughout this discussion that follows, it should be understood that the terms are used in the functional sense and not exclusively with reference to a specific embodiment, or implementation.

### DETAILED DESCRIPTION OF THE PREFERRED EMBODIMENTS

Discussion in this section is intended to provide a brief description of some exemplary embodiments of the present invention.

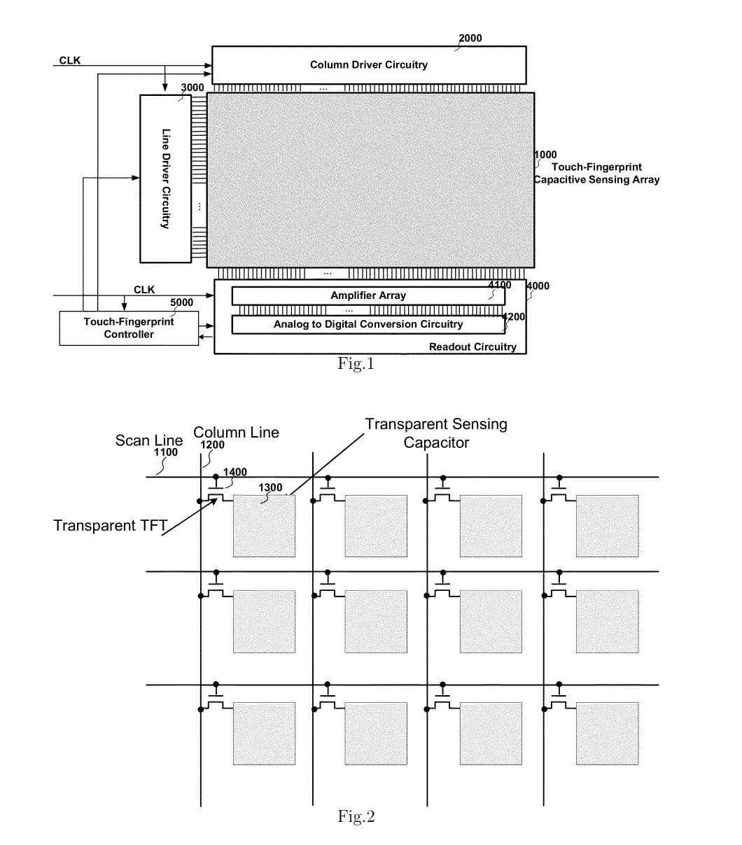

FIG. 1 is a block diagram showing, in one exemplary embodiment of the present invention, the components of a touch-fingerprint apparatus comprising, a transparent touch-fingerprint capacitive sensing array (1000), a multi-resolution scanline driver circuitry (3000), a column driver circuitry (2000), and a readout circuitry (4000) coupling with said transparent touch-fingerprint capacitive sensing array.

In an exemplary embodiment, a transparent touch-fingerprint capacitive sensing array (1000) can comprise a collection of capacitive sensing cells wherein the touch-fingerprint capacitive sensing array is optically transparent. A capacitive sensing cell can sense the capacitance change inducted by human touch and/or sense the capacitance differences produced by ridge and valley of human finger. Depending on the embodiments, a transparent touch-fingerprint capacitive sensing array can contain a matrix of capacitive sensing cells. A touch-fingerprint capacitive sensing array can be manufactured using transparent electronic devices and fabrication processes.

Depending on the embodiments, a capacitive sensing cell can comprise one or a plurality of transparent thin-film transistors, and/or transparent capacitive sensing component for sensing capacitance induced by human touch or capacitance difference between fingerprint ridges and valleys.

The degree of touch-fingerprint capacitive sensing array transparency is dependent of the embodiment. In accordance with the present invention, transparent TFTs can be implemented using transparent semiconductors (e.g., transparent amorphous oxide materials, transparent organic thin-film transistors, transparent in-organic thin-film transistors, transparent nano-wire transistors, transparent nano-tube transistors, etc).

In exemplary embodiments, transparent capacitance sensing component can be made using transparent capacitance sensing electrode (e.g., optically transparent conductive materials), and transparent dielectric. Transparent conductive materials include but not limited to transparent inorganic materials, or transparent organic materials, etc. Examples of inorganic materials include TCO (transparent conducting oxide), or fluorine doped tin oxide (FTO), or doped zinc oxide, etc.

In accordance of the present invention, a transparent touch-fingerprint capacitive sensing array (1000) can operate as either a fingerprint imager and/or a touch panel (e.g., multi-touch, or single touch panel) using capacitive sensing. In additional exemplary embodiments, a transparent touch-fingerprint capacitive sensing array can be configured and/or directed to sense touches and/or fingerprints by a touch-fingerprint controller.

Depending on the embodiments, a transparent touch-fingerprint capacitive sensing array can use transparent materials as substrate (e.g., glass, plastic).

In some exemplary embodiments of the present invention, a touch-fingerprint apparatus can comprise a multi-resolution scanline driver circuitry (3000). The multi-resolution scanline driver circuitry couples with the transparent touch-fingerprint capacitive sensing array. The scanline driver circuitry can select or activate rows of the capacitive sensing cells (e.g., row by row, a plurality of rows at a time).

In some exemplary embodiments of the present invention, a touch-fingerprint apparatus can comprise a multi-resolution column driver circuitry (2000). The multi-resolution column driver circuitry couples with the transparent touch-fingerprint capacitive sensing array. The column driver circuitry can select or activate columns of capacitive sensing cells (e.g., column by column, a plurality of columns in parallel).

Depending on the embodiments, scanline or column can be oriented in any direction. If one driver circuitry operates as scanline driver, the other one is column driver. The drawings that show scanline driver circuitry and column driver circuitry are for illustration purpose. The scope of the present invention should not be limited by the specific label, layout, or arrangement, or orientation of the scanline driver or column driver.

In exemplary embodiments of the present invention, a touch-fingerprint apparatus can comprise a readout circuitry (4000). The readout circuitry couples with the transparent touch-fingerprint capacitive sensing array. The readout circuitry can transmit digital or analog sensing output of selected capacitive sensing cells.

In some exemplary embodiments, capacitive sensing cells can have their unique column addresses or scanline addresses. A capacitive sensing cell can be selected by the scanline driver circuitry, and/or the column driver circuitry. Its sensing output can be transmitted over a data line or column line. The sensing output can be amplified and then converted into digital signal by a comparator or an analog-to-digital converter.

Depending on the embodiments, a touch-fingerprint apparatus can be controlled by a touch-fingerprint controller. A touch-fingerprint controller can direct the multi-resolution scanline driver circuitry, and/or the multi-resolution column driver circuitry to activate a subset of capacitive sensing cells.

In one embodiment of the present invention, a touch-fingerprint controller can direct the multi-resolution scanline driver circuitry, and/or the multi-resolution column driver circuitry to select scanlines or columns using subsampling. Scanlines or columns are activated with a distance value. In one embodiment, when a scanline or column is selected, the next selected scanline or column is separated from the current scanline or column by one or a plurality of scanlines or columns. As an example, a multi-resolution scanline driver circuitry can select every ten scanlines.

In further embodiments, depending on the implementations, the selected scanlines or columns can be activated one by one (e.g., through a multi-resolution shift register), or activated at the same time. In additional embodiments, the selected scanlines or columns can be divided into multiple groups where one selected scanline or column of each group is activated together. Then the next selected scanline or column of the group is activated.

In accordance of the present invention, in an embodiment, a transparent touch-fingerprint apparatus or a touch-fingerprint controller can use sensing cell subsampling to detect touch locations. With reduced scanline resolution or column resolution, a transparent touch-fingerprint apparatus or a touch-fingerprint controller can detect touch locations using output from fewer capacitive sensing cells. Furthermore, a transparent touch-fingerprint apparatus or a touch-fingerprint controller can use higher scanline and/or column resolutions for capturing fingerprint images.

Depending on the embodiment, when a transparent touch-fingerprint capacitive sensing array contains large number of scanlines and/or columns, to reduce delay to take a fingerprint image, a transparent touch-fingerprint apparatus or a touch-fingerprint controller can select scanlines and/or columns that are around a touch location.

In further embodiment, a transparent touch-fingerprint apparatus or a touch-fingerprint controller can first detect touch locations using reduced sampling resolution. Then the transparent touch-fingerprint apparatus or touch-fingerprint controller can select and/or activate the scanlines and/or columns that cover the touch location to capture one or multiple fingerprint images. A touch-fingerprint controller or transparent touch-fingerprint apparatus can compute a pair of column addresses as beginning and end column addresses, and/or compute a pair of scanline addresses as beginning and end scanline addresses. Then scanlines or columns within the beginning and end addresses are selected or activated.

In an embodiment of the present invention, a multi-resolution scanline driver circuitry, or a multi-resolution column driver circuitry, or a readout circuitry can be implemented using low temperature poly-silicon technology. In alternative embodiments, the multi-resolution scanline driver circuitry, or the multi-resolution column driver circuitry, or the readout circuitry can be implemented using amorphous silicon.

Depending on the implementation, in an exemplary embodiment, a touch-fingerprint apparatus can be fabricated using system-on-panel (SOP) or system-on-glass (COG) technology. Circuitry components of a touch-fingerprint apparatus can be integrated on a panel.

In one exemplary embodiment, a computing apparatus (e.g., laptop, or desk-top, or tablet, or notebook, or PDA, or mobile Internet device, or mobile phone, or handheld gaming device, or Kiosk) can comprise a transparent touch-fingerprint apparatus, an electronic display, one or a plurality of transceivers, a control processing element, one or a plurality of electronic storage devices. In additional embodiments, a computing apparatus can comprise a touch-fingerprint controller coupling with the transparent touch-fingerprint apparatus.

An electronic display is an output device for presentation of information in visual form (e.g., OLED displays, liquid crystal display devices such as TFT-LCD, electronic paper display, Interferometric modulator display, Electrowetting display).

In additional embodiments, a transparent touch-fingerprint apparatus can be integrated with an electronic display panel (e.g., OLED displays, liquid crystal display devices such as TFT-LCD, electronic paper display). Or in another embodiment, an electronic display panel can be placed beneath a transparent touch-fingerprint apparatus.

An electronic storage device is any medium that can be used to record information electronically (e.g., volatile DRAM, non-volatile storage, solid state drive, hard disk, flash memory). In an exemplary embodiment, an electronic storage device can comprise non-volatile random access memory. A non-volatile random access memory retains its information when power is turned off (non-volatile). The memory can be integrated on-chip (e.g., non-volatile SRAMs, on-chip flash memory) or it can be off-chip (e.g., flash memory, ferroelectric RAM, magnetoresistive random-access memory, phase-change memory, nano-RAM, millipede memory, resistive random-access memory) or integrated into a package.

A transceiver (e.g, RF transceiver, ethernet transceiver) is a device comprising both transmitter and receiver handling circuitry. A RF Transceiver uses RF (radio frequency) modules for data transmission.

Depending on the implementations, an embodiment of a computing apparatus can comprise one or a plurality of transceivers (e.g., WiFi transceivers, cellular transceivers, ethernet transceivers).

A computing apparatus can comprise one or a plurality of control processing elements. A control processing element is an electronic circuit which executes computer programs. A control processing element can be implemented as system on a chip (SoC). A system on a chip or system on chip (SoC or SOC) is an integrated circuit (IC) that integrates components of a computer or other electronic system into a single chip. It may contain digital, or analog, or mixed-signal, or radio-frequency functions all on a single chip substrate. Sometimes, a SoC processor designed for supporting applications executed by a mobile computing system (e.g., tablet, mobile phone, mobile Internet device, handheld gaming device, PDA) is called application processor.

It is worth to point out that the described embodiments are only for illustration purpose. Equivalent embodiments may be readily apparent to those of ordinary skill in the art. The present invention should not be limited only to the described embodiments herein.

FIG. 2 is a block diagram showing, in one exemplary embodiment of the present invention, a collection of capacitive sensing cells wherein a sensing cell comprises one transparent thin-film transistor.

In accordance with the present invention, In one exemplary embodiment, a transparent capacitive sensing array comprises a matrix of capacitive sensing cells. A fingerprint capacitive sensing cell connects to a scanline (1100), and a column line (1200). A capacitive sensing cell further comprises, a transparent sensing capacitor (1300), and a transparent thin-film transistor (1400) used for controlling the sensing operation of the cell. One terminal of the transparent thin-film transistor connects to the transparent electrode of the sensing capacitor, and the gate of the transparent thin-film transistor connects with a column line or a scanline. Output signals from the sensing cells are amplified (4100) and converted into digital signals (4200).

In accordance with the present invention, the transparent TFTs can be implemented using transparent organic thin-film transistors, or transparent in-organic thin-film transistors, or transparent amorphous oxide thin-film transistors, or transparent nano-wire transistors, or transparent nano-tube transistors, etc.

In one embodiment, the source and drain can be implemented using ITO or equivalent transparent conductive material.

In one embodiment, the gate electrode can be implemented using ITO or equivalent transparent conductive material.

An embodiment of the present invention can use any transparent thin-film transistors. The invention should not be limited only to transparent thin-film transistors mentioned herein.

In alternative embodiments, the transparent TFTs can be implemented using transparent nanowire based thin-film transistors. Transparent nanowire based TFT includes but not limited to, transparent ZnO nanowire transistor, transparent In₂O₃ nanowire transistor, or transparent SnO₂ nanowire transistor, or other transparent nanowire based TFT.

In one embodiment of the present invention, a transparent nanowire based thin-film transistor can comprise a substrate, a buffer, gate insulator, a gate electrode, a nanowire connecting a source and drain. The nanowire can be a single nanowire or a nanowire network. In some embodiments, a transparent nanowire transistor can be implemented using Si, or Si/Ge, or ZnO, or In₂O₃, or SnO₂, or Ge₁0X Mnx, or GaN, or other equivalent material.

In one embodiment, the buffer can be implemented using SiO₂ or equivalent material.

In an embodiment, the transparent capacitance sensing component can be implemented using transparent conductive oxide film. In further embodiments, the column lines, or scanlines can be implemented using transparent conducting films. Transparent conducting films (TCFs) are optically transparent and electrically conductive in thin layers. Transparent conducting films can be fabricated from either inorganic or organic materials.

It is worth to point out that the described embodiment is for illustration purpose. Equivalent embodiments of transparent capacitive sensing cells using transparent electronic components may be readily apparent to those of ordinary skill in the art. The present invention should not be limited only to the described embodiments herein.

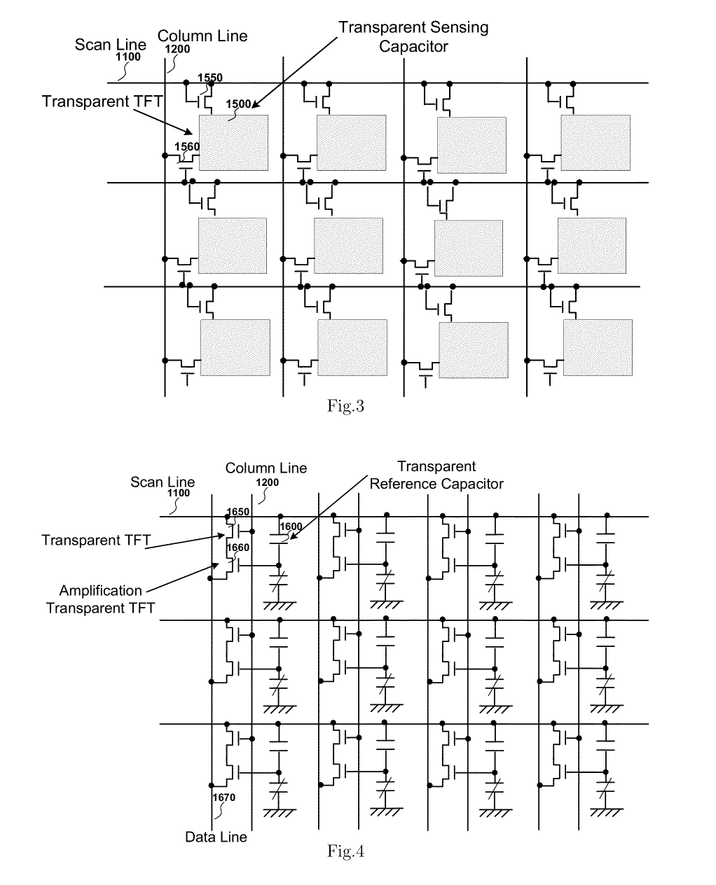

FIG. 3 is a block diagram showing, in one exemplary embodiment of the present invention, a collection of capacitive sensing cells wherein a sensing cell comprises two transparent thin-film transistors.

In accordance with the present invention, In one exemplary embodiment, a transparent capacitive sensing array comprises a matrix of capacitive sensing cells. A capacitive sensing cell connects to a scanline, and a column line. A capacitive sensing cell further comprises, a transparent sensing capacitor electrode (1500) and two transparent thin-film transistors (1550 and 1560). The transparent capacitive sensing electrode connects to terminals of the transparent thin-film transistors, and the gates of the two transparent thin-film transistors connect with two neighboring scanlines.

When the ridge of a fingerprint lies directly over the electrode, a capacitor is formed between the electrode and the finger, and this is charged through transistor (1550) when a row activation is applied. The stored charge is then transferred onto a column electrode through transistor (1560) when the following row is pulsed. The charge on the column is then integrated by external circuitry. If a trough in the fingerprint lies over the electrode, then the capacitance is very much smaller, and a negligible charge results. Output signals from the sensing cells are amplified and converted into digital signals.

In accordance with the present invention, the transparent TFTs can be implemented using transparent organic thin-film transistors, or transparent in-organic thin-film transistors, or transparent amorphous oxide thin-film transistors, or transparent nano-wire transistors, or transparent nano-tube transistors, etc.

An embodiment of the present invention can use any transparent thin-film transistors. The invention should not be limited only to the transparent thin-film transistors mentioned herein. It is worth to point out that the described embodiment is for illustration purpose. Equivalent embodiments of transparent fingerprint sensing cells using transparent electronic components may be readily apparent to those of ordinary skill in the art. The present invention should not be limited only to the described embodiments herein.

FIG. 4 is a block diagram showing, in one alternative exemplary embodiment of the present invention, a collection of capacitive sensing cells wherein a sensing cell comprises two transparent thin-film transistors.

In accordance with the present invention, in one embodiment, a transparent capacitive sensing array can comprise, a collection of scan lines, column lines, data lines, and a collection of capacitive sensing cells. A capacitive sensing cell connects to a data line (1670), a scan line, and a column line. The scan lines can connect to a scanline driver coupling with the capacitive sensing array. The column lines connect to a column driver coupling with the capacitive sensing array. Output signals from the data lines are amplified and converted into digital data.

In one embodiment, a capacitive sensing cell can comprise, a transparent reference capacitor (1600), and two transparent TFTs (thin-film transistors)(1650 and 1660). The transparent fingerprint capacitor comprises a transparent capacitance detecting electrode and a transparent capacitance-detecting dielectric layer. Capacitor formed by the fingerprint (ridge or valley) connects to the reference capacitor. One of the two electrodes of the reference capacitor connects to the scan line. The other electrode connects to the capacitance-detecting electrode.

When the scan line is set to be high in voltage (Vdd), the Vdd is applied to one electrode of the reference capacitor and shared between the reference capacitor and the fingerprint capacitor. Gate electrode of the amplification transparent TFT (1660) is connected to the capacitance-detecting electrode. In one embodiment, the gate potential of the amplification TFT changes in accordance with the surface contours of a fingerprint. One terminal electrode of the amplification TFT connects to a data line and the other terminal connects to a scan line. Gate electrode of the second transparent TFT connects to the column line. It is situated in between the scan line and the amplification transparent TFT. In one embodiment, the amplification TFT enters the on-state when a valley of a fingerprint is present over the capacitance-detecting dielectric layer. When a ridge of a fingerprint is in contact with the capacitance detecting dielectric layer, the amplification TFT enters the off-state.

It is worth to point out that the described embodiment is for illustration purpose. Equivalent embodiments of transparent fingerprint sensing cells using transparent electronic components may be readily apparent to those of ordinary skill in the art. The present invention should not be limited only to the described embodiments herein.

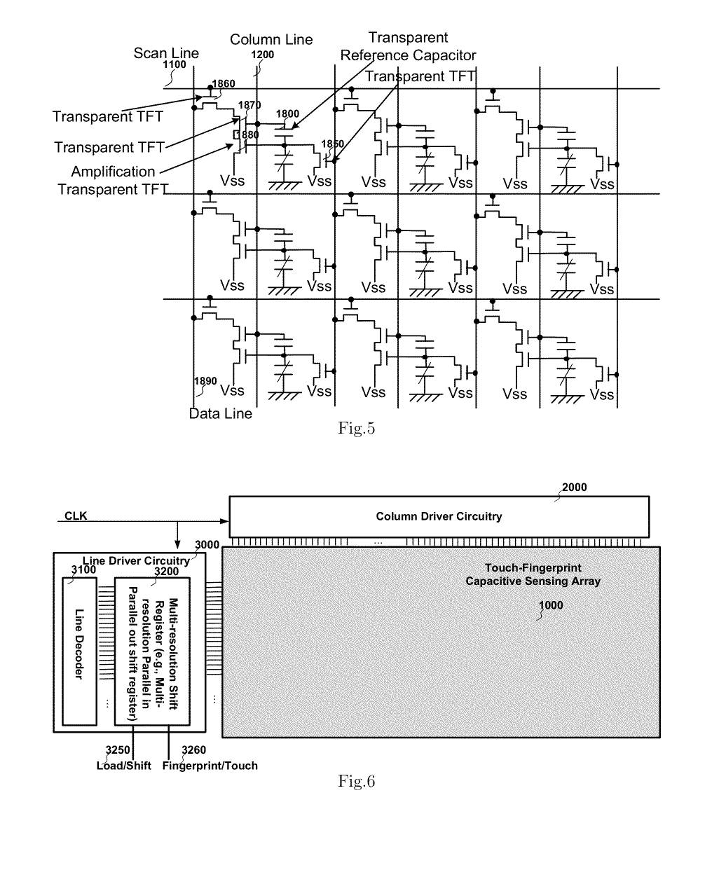

FIG. 5 is a block diagram showing, in one alternative exemplary embodiment of the present invention, a collection of capacitive sensing cells wherein a sensing cell comprises four transparent thin-film transistors and one reference capacitor.

In accordance with the present invention, in one embodiment, a transparent capacitive sensing array can comprise, a collection of scan lines, column lines, data lines, and a collection of capacitive sensing cells. A capacitive sensing cell connects to a data line, a scan line, and a column line. The scan lines can connect to a scanline driver coupling with the capacitive sensing array. The column lines connect to a column driver coupling with the capacitive sensing array. Output signals from the data lines are amplified and converted into digital data.

In one embodiment, a capacitive sensing cell can comprise, a transparent reference capacitor (1800), two transparent switching TFTs (thin-film transistors) (1860 and 1870), and one transparent amplification transistor (1880). The transparent capacitor comprises a transparent capacitance detecting electrode and a transparent dielectric layer. One of the two electrodes of the reference capacitor is connected to the column line. The other electrode is connected to the capacitance-detecting electrode.

When the column line is set to be high in voltage (Vdd), the Vdd is applied to one electrode of the reference capacitor and shared between the reference capacitor and the capacitor formed by the finger. Gate electrode of the amplification transparent TFT is connected to the capacitance-detecting electrode. In one embodiment, the gate potential of the amplification TFT changes in accordance with the surface contours of a fingerprint. One terminal electrode of the amplification TFT connects to a data line and the other terminal connects to Vss. Gate electrode of a second transparent TFT connects to the column line. It is situated in between the first transparent TFT and the amplification transparent TFT. In one embodiment, the amplification TFT enters the on-state when a valley of a fingerprint is present over the capacitance-detecting dielectric layer. When a ridge of a fingerprint is in contact with the capacitance detecting dielectric layer, the amplification TFT enters the off-state. A fourth transparent TFT with its gate connecting to the next column line.

It is worth to point out that the described embodiment is for illustration purpose. Equivalent embodiments of transparent capacitive sensing cells using transparent electronic components may be readily apparent to those of ordinary skill in the art. The present invention should not be limited only to the described embodiments herein.

FIG. 6 is a block diagram, in one exemplary embodiment of the present invention, a scanline driver circuitry comprising a line decoder and a multi-resolution shift register.

In one exemplary embodiment of the present invention, a line address decoder (3100) can decode a line address and send the decoded output to a shift register (3200) (e.g., parallel-in parallel-out shift register, serial-in parallel-out shift register, multi-resolution shift register). The shift register can activate one row of fingerprint sensing cells at a time.

In one exemplary embodiment, the fingerprint sensing cells in the enabled row can be addressed during a clock cycle and disabled after results of the sensing cells are amplified, converted into digital values. In further embodiments, the digital output can be fed into a storage component (physical storage used to temporarily hold data such as latches, flip-flops, or buffers). Sensed results stored in the storage component are selected and transmitted to a touch-fingerprint controller.

In one embodiment of the present invention, a touch-fingerprint controller can direct a multi-resolution scanline driver circuitry, to select or activate scanlines using multi-resolution levels. In accordance with the present invention, a shift register can support a plurality of stride values. Stride is the distance between two consecutive or neighboring selected scanlines. In one embodiment, when a scanline is selected or activated, the next selected or activated scanline is separated from the current scanline or column by one or a plurality of scanlines. As an example, a multi-resolution scanline driver circuitry can select every ten scanlines. In an embodiment, a touch-fingerprint apparatus can support multiple stride values. As an example, when stride value is set to be 1, the scanline driver circuitry can select or activate the next scanline in sequence in a way similar to a regular shift register. When stride value is set to be 10, the scanline driver circuitry can select or activate the next scanline with 10 as the distance.

In accordance of the present invention, in an embodiment, a transparent touch-fingerprint apparatus or a touch-fingerprint controller can use low resolution sensing cell sampling to detect touch locations. With reduced scanline resolution or column resolution, a transparent touch-fingerprint apparatus or a touch-fingerprint controller can detect touch locations using output from fewer capacitive sensing cells. Furthermore, a transparent touch-fingerprint apparatus or a touch-fingerprint controller can use higher scanline resolution and/or column resolution for capturing fingerprint images. In an exemplary embodiment, a scanline driver circuitry can use different stride values for touch sensing and fingerprint imaging. As an example, the stride value for touch sensing can be larger than the stride value for fingerprint imaging.

In an exemplary embodiment, a scanline driver circuitry can comprise one or a plurality of control signals. In one exemplary embodiment, a scanline driver circuitry can comprise a control signal indicting whether it is to sense touch locations or fingerprint images (3260). In additional embodiment, a scanline driver circuitry can comprise a control signal indicting whether the shift register works in input mode or shift mode (3250).

In some embodiments, a transparent touch-fingerprint capacitive sensing array may contain large number of scanlines and/or columns, to reduce delay to take a fingerprint image, a transparent touch-fingerprint apparatus or a touch-fingerprint controller can select scanlines and/or columns that are around a touch location. In further embodiment, a transparent touch-fingerprint apparatus or a touch-fingerprint controller can first detect touch location using reduced sampling resolution. Then the transparent touch-fingerprint apparatus or touch-fingerprint controller can select and/or activate the scanlines and/or columns that cover the touch location to capture one or multiple fingerprint images. A touch-fingerprint controller or transparent touch-fingerprint apparatus can compute a pair of column addresses as beginning and end column addresses, and/or compute a pair of scanline addresses as beginning and end scanline addresses. Then scanlines or columns within the beginning and end addresses are selected or activated.

It is worth to point out that the described embodiment is for illustration purpose. Equivalent embodiments of the described scanline driver circuitry may be readily apparent to those of ordinary skill in the art. The present invention should not be limited only to the described embodiments herein.

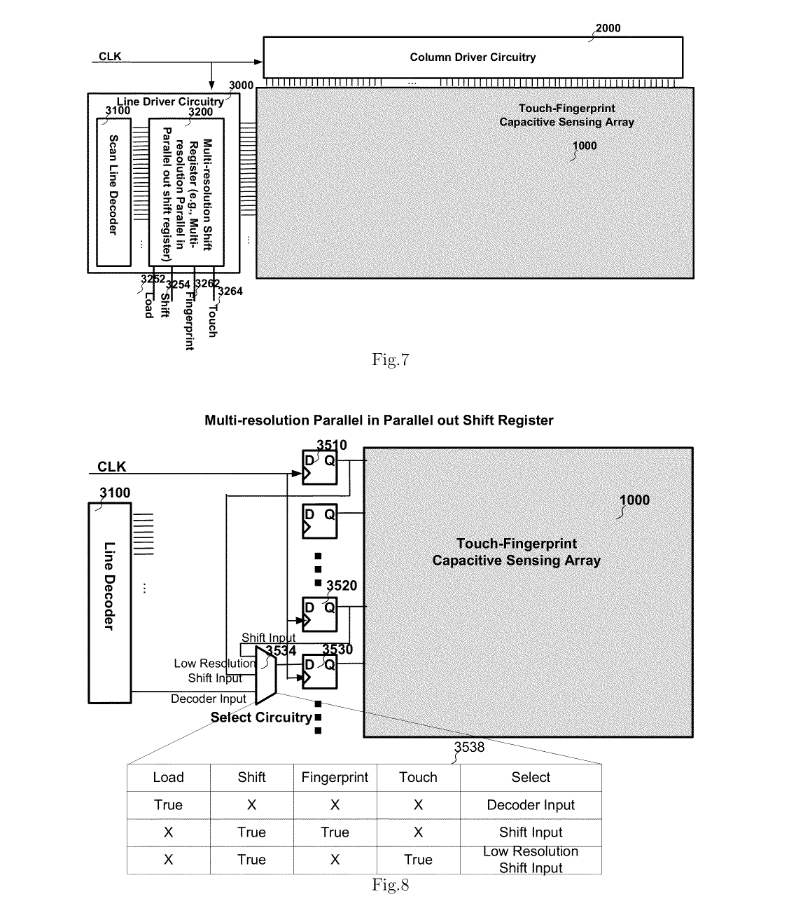

FIG. 7 is a block diagram, in one alternative exemplary embodiment of the present invention, a scanline driver circuitry comprising a line decoder and a multi-resolution shift register.

In one exemplary embodiment of the present invention, a line address decoder can decode a line address and send the decoded output to a shift register (e.g., parallel-in parallel-out shift register, serial-in parallel-out shift register, multi-resolution shift register). The shift register can activate one row of fingerprint sensing cells at a time.

In an exemplary embodiment, a scanline driver circuitry can comprise one or a plurality of control signals. In one exemplary embodiment, a scanline driver circuitry can comprise a control signal indicting whether it is to sense touch locations (3264). In further embodiments, a scanline driver circuitry can comprise a control signal indicting whether it is to sense fingerprint images (3262). In additional embodiments, a scanline driver circuitry can comprise a control signal indicting whether the shift register works in input mode (3252) or comprise a control signal indicting whether the shift register works in shift mode (3254).

FIG. 8 is a block diagram, in one exemplary embodiment of the present invention, components of a multiple resolution shift register.

In one exemplary embodiment of the present invention, a scanline address decoder can decode a line address and send the decoded output to a shift register (e.g., parallel-in parallel-out shift register, serial-in parallel-out shift register, multi-resolution shift register). The shift register can activate one row of fingerprint sensing cells at a time.

Depending on the embodiments, a multi-resolution shift register can be implemented as a parallel-in or serial-in shift register.

In accordance with the present invention, a shift register can support a plurality of stride values. In some exemplary embodiments, a shift register can comprise a collection of storage components (3510 or 3520 or 3530) (e.g., latch, flip-flop, buffer). A storage component can store one bit setting of a scanline. Depending on the implementation, in some embodiments, a storage component of a shift register can be set by output from a scanline decoder that couples with the shift register. In addition, a storage component (e.g., latch, flip-flop, buffer) can connect its output as one of the input to a neighboring storage component. In some embodiments, for implementing a multi-resolution shift register, a subset of storage components of a shift register can have their input from multiple storage components. A storage component may send its output to multiple storage components. In an exemplary embodiment, a storage component may receive input connections from a plurality of neighbors of different distances. For example, a storage component may receive two input connections, one from a close neighbor, and the other one from a neighbor at certain distance (based on the stride value of a multi-resolution shift register). In embodiments of a parallel-in shift register, a storage component may receive input from the scanline decoder. A storage component can use a selector to choose which input should be used as the next scanline setting.

The figure shows an exemplary implementation of the selector logic (3538). When in shift mode, if a touch-fingerprint apparatus is to detect touches or is in a low resolution mode, the selector of a storage component (3534) can choose an input sent from a storage component at certain distance according to the stride value. If a touch-fingerprint apparatus is to capture fingerprint images or is in a high resolution mode, the selector of a storage component can choose an input sent from a storage component at a closer distance. Depending on the implementation, a multi-resolution shift register may support two or more than two resolution levels. In the figure, symbol X means that “don't care”.

It is worth to point out that the described embodiment is for illustration purpose. Equivalent embodiments of the described multi-resolution shift register may be readily apparent to those of ordinary skill in the art. The present invention should not be limited only to the described embodiments herein.

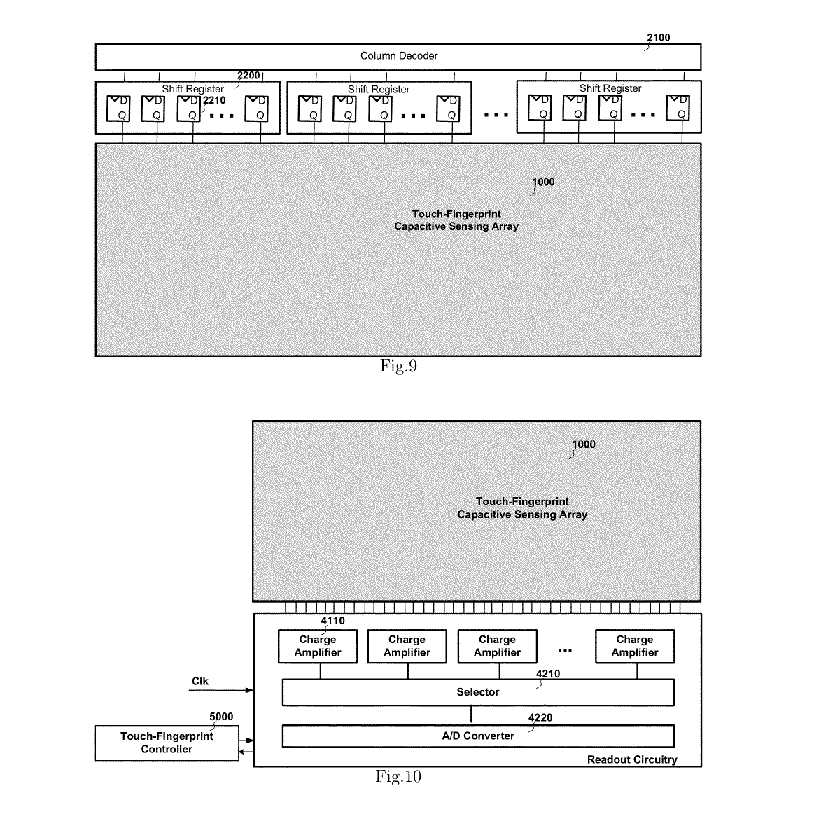

FIG. 9 is a block diagram showing, in one exemplary embodiment of the present invention, the components of a column driver circuitry.

Depending on the embodiments, a touch-fingerprint apparatus can comprise a multi-resolution column driver circuitry. In further embodiments, a multi-resolution column driver circuitry can comprise a column decoder (2100), and one or a plurality of shift registers (2200).

In one embodiment of the present invention, a touch-fingerprint controller can direct a multi-resolution column circuitry to select columns using subsampling with a distance value. Depending on the implementation, columns can be activated in parallel, or sequentially, or in a hybrid mode where a subset of columns are activated in parallel.

In accordance of the present invention, in an exemplary embodiment, a transparent touch-fingerprint apparatus or a touch-fingerprint controller can use sensing cell subsampling to detect touch locations. With reduced column resolution, a transparent touch-fingerprint apparatus or a touch-fingerprint controller can detect touch locations using output from fewer capacitive sensing cells. Furthermore, a transparent touch-fingerprint apparatus or a touch-fingerprint controller can use higher column resolutions for capturing fingerprint images.

In an exemplary embodiment, the selected columns can be activated one by one (e.g., through a multi-resolution shift register). An embodiment can use different column stride value (column distance between two selected columns). For touch sensing, a larger column stride value can be used. For fingerprint imaging, a smaller column stride value may be used. In an exemplary embodiment, a column driver circuitry can activate the selected columns in parallel.

In additional embodiments, columns can be divided into multiple groups as shown in the figure. A shift register connects to a group of columns. In further embodiments, columns from different groups can be activated in parallel. Within a group, columns are selected or activated sequentially using a shift register (e.g., shift register, multi-resolution shift register, multi-resolution serial-in shift register, multi-resolution parallel-in shift register).

Depending on the embodiment, when a transparent touch-fingerprint capacitive sensing array contains large number of columns, to reduce delay to take a fingerprint image, a transparent touch-fingerprint apparatus or a touch-fingerprint controller can select columns that are around a touch location.

In further embodiment, a transparent touch-fingerprint apparatus or a touch-fingerprint controller can first detect touch locations using reduced sampling resolution. Then the transparent touch-fingerprint apparatus or touch-fingerprint controller can select and/or activate columns that cover a touch location to capture one or multiple fingerprint images. A touch-fingerprint controller or transparent touch-fingerprint apparatus can compute a pair of column addresses as beginning and end column addresses. Then columns within the beginning and end addresses are selected or activated.

It is worth to point out that the described embodiment is for illustration purpose. Equivalent embodiments of the described column driver circuitry may be readily apparent to those of ordinary skill in the art. The present invention should not be limited only to the described embodiments herein.

FIG. 10 is a block diagram showing, in one exemplary embodiment of the present invention, components of a readout circuitry.

In an exemplary embodiment, a readout circuitry can comprise a collection of charge amplifiers. A charge amplifier can amplify the output signals of connected capacitive sensing cells. In some embodiments, a column connects to a charge amplifier. In alternative embodiments, a plurality of columns can share a charge amplifier. Depending on the implementation, a charge amplifier can perform tasks including but not limited to, converting the charge to voltage, or amplifying the charge at the input of the operation amplifier, or rejecting the stray capacitance.

In some embodiments, a charge amplifier can use additional circuitry for offset compensation. For example, a charge amplifier can use correlated double sampling technology for offset compensation.

In additional embodiments, a readout circuitry can comprise one or multiple selectors (4210) (e.g., multiplexer) that couple with the charge amplifiers. Depending on the implementation, the selector may consist of switches that connect the output of the charge amplifier to the input of an analog-to-digital converter (4220) sequentially. The analog-to-digital converter converts the output voltage of the charge amplifiers to a digital value. In further embodiments, output of the analog-to-digital converter is transmitted to a touch-fingerprint controller. In some embodiments, after receiving the digital data, the touch-fingerprint controller can process the data to determine the touch events or touch locations, or process the data to assemble fingerprint images. A touch-fingerprint controller may comprise memories for processing and storing the sensed data.

It is worth to point out that the described embodiment is for illustration purpose. Equivalent embodiments of the described readout circuitry may be readily apparent to those of ordinary skill in the art. The present invention should not be limited only to the described embodiments herein.

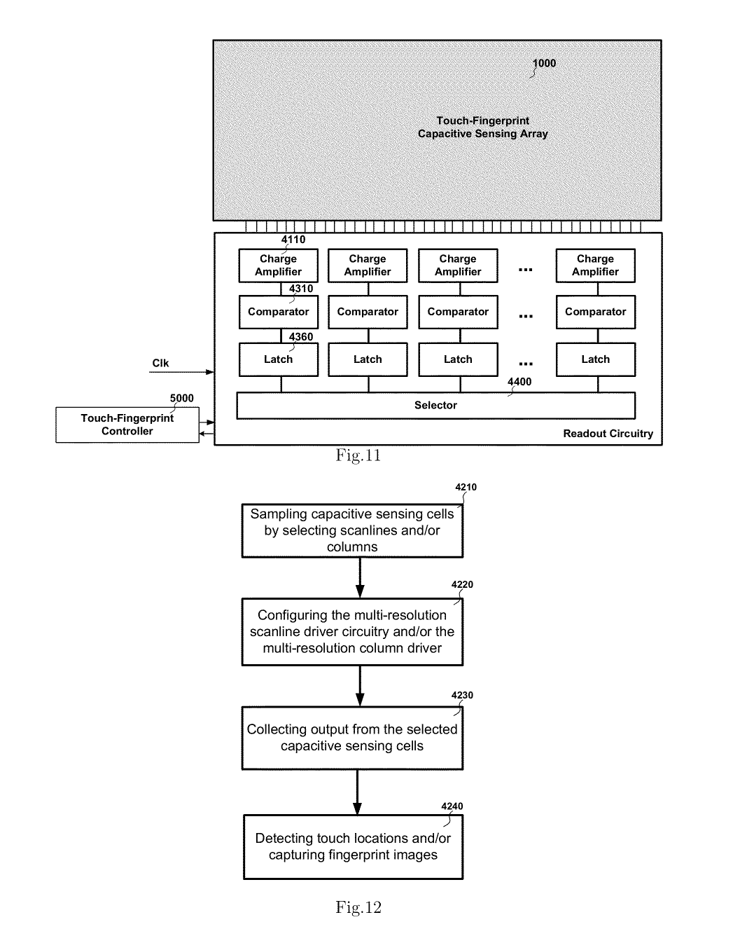

FIG. 11 is a block diagram showing, in one exemplary embodiment of the present invention, components of a readout circuitry.

In an exemplary embodiment, a readout circuitry can comprise a collection of charge amplifiers. A charge amplifier can amplify the output signals of connected capacitive sensing cells. In some embodiments, a column connects to a charge amplifier. In alternative embodiments, a plurality of columns can share a charge amplifier. In some embodiments, a charge amplifier can use additional circuitry for offset compensation. For example, a charge amplifier can use correlated double sampling technology for offset compensation.

In additional embodiments, a readout circuitry can comprise one or multiple comparators (4310) that couple with the charge amplifiers. A comparator can convert analog signals from capacitive sensing cell into digital signals to represent fingerprint. Depending on the implementations, a comparator can be implemented using TFT based comparator circuit. The output of a comparator can be a binary value. The digital output of the comparators can be stored in a collection of electronic storage components (4360) (e.g., latch, flip-flop, buffer). In further embodiments, a readout circuitry can comprise a selector (e.g., multiplexer) that couple with the storage components. Depending on the implementation, the selector (4400) may consist of switches that transmit the digital output stored in the electronic storage components to a touch-fingerprint controller sequentially. In additional exemplary embodiments, after receiving the digital data, the touch-fingerprint controller can process the data to determine the touch events or touch locations, or process the data to assemble fingerprint images. A touch-fingerprint controller may comprise memories for processing and storing the sensed data.

It is worth to point out that the described embodiment is for illustration purpose. Equivalent embodiments of the described readout circuitry may be readily apparent to those of ordinary skill in the art. The present invention should not be limited only to the described embodiments herein.

FIG. 12 is a flowchart showing, in one exemplary embodiment of the present invention, the process of sensing touches and/or fingerprints with a touch-fingerprint apparatus. Depending on the embodiments, a touch-fingerprint apparatus can comprise, a transparent touch-fingerprint capacitive sensing array wherein the transparent touch-fingerprint capacitive sensing array comprises a collection of capacitive sensing cells, a multi-resolution scanline driver circuitry, a multi-resolution column driver circuitry, and a readout circuitry.

In accordance with the present invention, in an exemplary embodiment, a touch-fingerprint apparatus or a touch-fingerprint controller coupling with a touch-fingerprint apparatus can, sample capacitive sensing cells of a transparent touch-fingerprint sensing array by selecting a collection of scanlines and/or columns (4210); configure the multi-resolution scanline driver circuitry and/or the multi-resolution column driver to activate the selected scanlines and/or columns (4220); collect output from the selected capacitive sensing cells (4230); and detect touch locations and/or capture fingerprint images by the touch-fingerprint controller (4240).

In some embodiments of the present invention, a touch-fingerprint controller can direct a multi-resolution scanline driver circuitry, and/or a multi-resolution column circuitry to select scanlines or columns using subsampling. Scanlines or columns are activated with a distance value. In further embodiments, depending on the implementations, the selected scanlines or columns can be activated one by one (e.g., through a multi-resolution shift register). In additional embodiments, selected columns can be activated in parallel. Furthermore, the selected columns can be divided into multiple groups where one selected column of each group is activated in parallel. Then the next selected column of the group is activated.

In accordance of the present invention, in an embodiment, a transparent touch-fingerprint apparatus or a touch-fingerprint controller can use sensing cell subsampling to detect touch locations. With reduced scanline resolution or column resolution, a transparent touch-fingerprint apparatus or a touch-fingerprint controller can detect touch locations using output from fewer capacitive sensing cells.

In additional exemplary embodiments, a transparent touch-fingerprint apparatus or a touch-fingerprint controller can use higher scanline resolution and/or higher column resolution for capturing fingerprint images. Depending on the embodiments, when a transparent touch-fingerprint capacitive sensing array contains large number of scanlines and/or columns, to reduce delay to take a fingerprint image, a transparent touch-fingerprint apparatus or a touch-fingerprint controller can select scanlines and/or columns that are around a touch location.

In further embodiments, a transparent touch-fingerprint apparatus or a touch-fingerprint controller can first detect touch location by sampling a subset of capacitive sensing cells. Then the transparent touch-fingerprint apparatus or touch-fingerprint controller can select and/or activate the scanlines and/or columns that cover q touch location to capture one or multiple fingerprint images. A touch-fingerprint controller or transparent touch-fingerprint apparatus can compute a pair of column addresses as beginning and end column addresses (e.g., ranges of columns), and/or compute a pair of scanline addresses as beginning and end scanline addresses (e.g., ranges of scanlines). Then the transparent touch-fingerprint apparatus or touch-fingerprint controller can collect output from the selected capacitive sensing cells by setting the multi-resolution scanline driver circuitry and/or the multi-resolution column driver circuitry.

It is worth to point out that the described embodiment is for illustration purpose. Equivalent embodiments of the described touch and/or fingerprint sensing approach may be readily apparent to those of ordinary skill in the art. The present invention should not be limited only to the described embodiments herein.

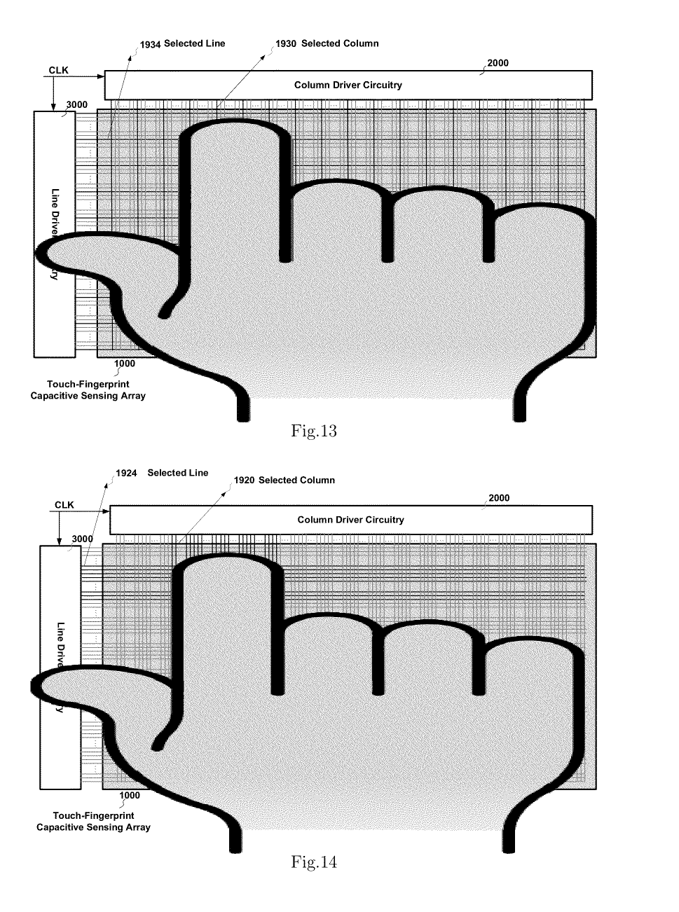

FIG. 13 is a block diagram showing, in one exemplary embodiment of the present invention, selected columns and scanlines with subsampling (e.g., scanlines or columns in dark color).

In accordance with the present invention, in an exemplary embodiment, a touch-fingerprint apparatus or a touch-fingerprint controller coupling with a touch-fingerprint apparatus can, sample capacitive sensing cells of a transparent touch-fingerprint sensing array by selecting a collection of scanlines and/or columns; configure the multi-resolution scanline driver circuitry and/or the multi-resolution column driver to activate the selected scanlines and/or columns; collect output from the selected capacitive sensing cells; and detect touch locations and/or capture fingerprint images by the touch-fingerprint controller.

In some embodiments of the present invention, a touch-fingerprint controller can direct a multi-resolution scanline driver circuitry, and/or a multi-resolution column circuitry to select scanlines or columns using subsampling (1934 and 1930). Scanlines or columns are activated with a distance value. In further embodiments, depending on the implementations, the selected scanlines or columns can be activated one by one (e.g., through a multi-resolution shift register). In additional embodiments, selected columns can be activated in parallel. Furthermore, the selected columns can be divided into multiple groups where one selected column of each group is activated in parallel. Then the next selected column of the group is activated.

In accordance of the present invention, in an embodiment, a transparent touch-fingerprint apparatus or a touch-fingerprint controller can use sensing cell subsampling to detect touch locations. With reduced scanline resolution or column resolution, a transparent touch-fingerprint apparatus or a touch-fingerprint controller can detect touch locations using output from fewer capacitive sensing cells.

It is worth to point out that the described embodiment is for illustration purpose. Equivalent embodiments of the described touch sensing approach may be readily apparent to those of ordinary skill in the art. The present invention should not be limited only to the described embodiments herein.

FIG. 14 is a block diagram showing, in one exemplary embodiment of the present invention, selected columns and/or scanlines in fingerprint imaging (e.g., scanlines or columns in dark color).

In accordance with the present invention, in an exemplary embodiment, a touch-fingerprint apparatus or a touch-fingerprint controller coupling with a touch-fingerprint apparatus can, sample capacitive sensing cells of a transparent touch-fingerprint sensing array by selecting a collection of scanlines and/or columns; configure the multi-resolution scanline driver circuitry and/or the multi-resolution column driver to activate the selected scanlines and/or columns; collect output from the selected capacitive sensing cells; and capture fingerprint images by the touch-fingerprint controller.

Depending on the embodiments, when a transparent touch-fingerprint capacitive sensing array contains large number of scanlines and/or columns, to reduce delay to take a fingerprint image, a transparent touch-fingerprint apparatus or a touch-fingerprint controller can select scanlines and/or columns that are around a touch location (1924 and 1920).

In further embodiments, a transparent touch-fingerprint apparatus or a touch-fingerprint controller can first detect touch location by sampling a subset of capacitive sensing cells. Then the transparent touch-fingerprint apparatus or touch-fingerprint controller can select and/or activate the scanlines and/or columns that cover a touch location to capture one or multiple fingerprint images. A touch-fingerprint controller or transparent touch-fingerprint apparatus can compute a pair of column addresses as beginning and end column addresses (e.g., ranges of columns), and/or compute a pair of scanline addresses as beginning and end scanline addresses (e.g., ranges of scanlines). Then the transparent touch-fingerprint apparatus or touch-fingerprint controller can collect output from the selected capacitive sensing cells by setting the multi-resolution scanline driver circuitry and/or the multi-resolution column driver circuitry.

It is worth to point out that the described embodiment is for illustration purpose. Equivalent embodiments of the described touch and/or fingerprint sensing approach may be readily apparent to those of ordinary skill in the art. The present invention should not be limited only to the described embodiments herein.

What is claimed is:

1. A touch-fingerprint apparatus comprising,
a transparent touch-fingerprint capacitive sensing array comprising a collection of capacitive sensing cells wherein said touch-fingerprint capacitive sensing array is optically transparent;
a multi-resolution scanline driver circuitry coupling with said transparent touch-fingerprint capacitive sensing array wherein said scanline driver circuitry can select or activate rows of capacitive sensing cells;
a column driver circuitry coupling with said transparent touch-fingerprint capacitive sensing array wherein said column driver circuitry can select or activate columns of capacitive sensing cells; and
a readout circuitry coupling with said transparent touch-fingerprint capacitive sensing array wherein said readout circuitry can transmit digital or analog output of selected capacitive sensing cells.

2. The apparatus in claim 1 wherein a capacitive sensing cell further comprising, a transparent capacitance sensing electrode and a transparent thin-film transistor wherein one terminal of the transparent thin-film transistor connects to the transparent capacitance sensing electrode and the gate of the transparent thin-film transistor connects to a column line or a scanline.

3. The apparatus in claim 1 wherein a capacitive sensing cell further comprising, a transparent capacitance sensing electrode and two transparent thin-film transistors wherein the transparent capacitance sensing electrode connects to terminals of the transparent thin-film transistors, and the gates of the two transparent thin-film transistors connect to two neighboring scanlines.

4. The apparatus in claim 1 wherein a capacitive sensing cell further comprising, a transparent capacitance sensing electrode and a plurality of transparent thin-film transistors wherein one of the transparent thin-film transistors acts as an amplification transistor wherein the capacitance sensing electrode connects to the gate of the amplification transistor and the sensed capacitance induced by touch or fingerprint is amplified.

5. The apparatus in claim 1 wherein the multi-resolution scanline driver circuitry further comprising, a scanline decoder, and a multi-resolution shift register coupling with the scanline decoder.

6. The apparatus in claim 5 wherein the multi-resolution shift register further comprising a multi-resolution parallel in parallel out shift register.

7. The apparatus in claim 1 wherein the column driver circuitry is a multi-resolution column driver circuitry.

8. The apparatus in claim 1 wherein the column driver circuitry further comprising, a column decoder, and one or a plurality of shift registers.

9. The apparatus in claim 8 wherein the shift register is a multi-resolution shift register, or a parallel in parallel out shift register, or a serial in parallel out shift register.

10. The apparatus in claim 1 wherein the readout circuitry further comprising, a collection of charge amplifiers wherein said charge amplifiers amplify the output signals of capacitive sensing cells, a selector coupling with the charge amplifiers, and at least one analog-to-digital converter.

11. The apparatus in claim 1 wherein the readout circuitry further comprising, a collection of charge amplifiers wherein said charge amplifiers amplify the output signals of capacitive sensing cells, and a collection of comparators coupling with the charge amplifiers wherein said comparators convert the amplified signals into digital outputs.

12. A method of sensing touches and/or fingerprints using a touch-fingerprint apparatus wherein said touch-fingerprint apparatus comprising, a transparent touch-fingerprint capacitive sensing array wherein said transparent touch-fingerprint capacitive sensing array comprising a collection of capacitive sensing cells, a multi-resolution scanline driver circuitry, a multi-resolution column driver circuitry, and a readout circuitry, said method comprising,
sampling capacitive sensing cells by selecting a collection of scanlines and/or columns;
configuring the multi-resolution scanline driver circuitry and/or the multi-resolution column driver circuitry to activate the selected scanlines and/or columns;
collecting output from the selected capacitive sensing cells; and
detecting touch locations and/or capturing fingerprint images.

13. The method in claim 12 wherein touch locations are detected, the method further comprising, sampling scanlines wherein the sampled neighboring scanlines are separated by a plurality of scanlines, and/or sampling columns wherein the sampled neighboring columns are separated by a plurality of columns.

14. The method in claim 12 wherein fingerprint image is captured, the method further comprising,
determining touch location or touch locations by sampling a subset of capacitive sensing cells;
selecting a collection of capacitive sensing cells by choosing at least a range of scanlines and/or choosing at least a range of columns wherein the sensing area formed by the selected scanlines and/or selected columns contains at least one touch location; and
collecting output from the selected capacitive sensing cells by setting the multi-resolution scanline driver circuitry and/or setting the multi-resolution column driver circuitry;

15. A computing apparatus comprising,
an electronic display;
one or a plurality of transceivers;
a control processing element;
one or a plurality of electronic storage devices; and
a touch-fingerprint apparatus wherein said touch-fingerprint apparatus further comprising, a transparent touch-fingerprint capacitive sensing array comprising a collection of capacitive sensing cells wherein said touch-fingerprint capacitive sensing array is optically transparent, and a touch-fingerprint controller wherein said touch-fingerprint controller can configure said touch-fingerprint capacitive sensing array to detect touch locations and/or to capture fingerprint images.

16. The apparatus in claim 15 wherein the touch-fingerprint apparatus further comprising,
a multi-resolution scanline driver circuitry coupling with said transparent touch-fingerprint capacitive sensing array wherein said scanline driver circuitry can select or activate rows of capacitive sensing cells;
a multi-resolution column driver circuitry coupling with said transparent touch-fingerprint capacitive sensing array wherein said column driver circuitry can select or activate columns of capacitive sensing cells; and
a readout circuitry coupling with said transparent touch-fingerprint capacitive sensing array wherein said readout circuitry can transmit digital or analog output of selected capacitive sensing cells.

17. The apparatus in claim 15 wherein the capacitive sensing cell further comprising, a transparent capacitance sensing electrode and a transparent thin-film transistor wherein one terminal of the transparent thin-film transistor connects to the transparent capacitance sensing electrode and the gate of the transparent thin-film transistor connects to a column line or a scanline.

18. The apparatus in claim 15 wherein the capacitive sensing cell further comprising, a transparent capacitance sensing electrode and two transparent thin-film transistors wherein the transparent capacitance sensing electrode connects to terminals of the transparent thin-film transistors, and the gates of the two transparent thin-film transistors connect to two neighboring scanlines.

19. The apparatus in claim 15 wherein the touch-fingerprint apparatus further comprising a touch detecting processor wherein said touch detecting processor is programmed to,
sample scanlines wherein the sampled neighboring scanlines are separated by a plurality of scanlines, and/or sample columns wherein the sampled neighboring columns are separated by a plurality of columns;
collect output from the selected capacitive sensing cells; and
detect touch locations.

20. The apparatus in claim 15 wherein the touch-fingerprint apparatus further comprising a fingerprint imaging processor wherein said fingerprint imaging processor is programmed to,
determine touch location or touch locations by sampling a subset of capacitive sensing cells;
select a collection of capacitive sensing cells by choosing at least one range of scanlines and/or choosing at least a range of columns wherein the sensing area formed by the selected scanlines and/or selected columns contains at least one touch location; and
capture one or a plurality of fingerprint images with output from the selected capacitive sensing cells.
